(19) United States
(12) Patent Application Publication
(10) Pub. No.: US 2018/0115982 A1
(43) Pub. Date: Apr. 26, 2018

(54) TECHNIQUES FOR RELIABLE MULTICAST IN WLAN

(71) Applicant: QUALCOMM Incorporated, San Diego, CA (US)

(72) Inventors: Krishna Mohan REDDY, Bangalore (IN); Atul Suresh JOSHI, Pune (IN)

(21) Appl. No.: 15/298,507

(22) Filed: Oct. 20, 2016

(51) Int. Cl. H04W 72/12; H04L 5/00; H04W 72/00; H04W 72/08; H04B 17/318

(52) U.S. Cl. CPC H04W 72/1226; H04L 5/0055; H04W 88/08; H04W 72/085; H04B 17/318; H04W 72/005

(57) ABSTRACT

Aspects of the present disclosure provide a method to select a plurality of leader stations (STAs) that may respond with an ACK message to a plurality of multicast frames broadcasted by the transmitting device (e.g., Access Point (AP) or another STA). For each multicast frame broadcasted, a different leader STA may be scheduled to respond with an ACK message. The leader STAs may be selected based on the measured signal quality and signal strength. Specifically, the transmitting device may select STAs that experience the poorest signal by comparison to other STAs on the network as the leader STAs to respond with an ACK message on a rotational basis.

### BACKGROUND

The deployment of wireless local area networks (WLANs) in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. A set of STAs can communicate with each other through a common AP in what is referred to as a basic service set (B SS). However, some WLAN network deployments may be dense (e.g., have a large number of STAs deployed within the coverage area of multiple APs), which may result in issues related to channel or medium usage. In other examples, the wireless network may be configured as an “ad-hoc” communication system in which terminals asynchronously communicate directly with each other without use of any specific AP referred to as an independent BSS (IBSS). Additionally, WLANs can be organized as a wireless mesh network (WMN) that is made up of radio nodes organized in a mesh topology. In some examples, the WLAN devices within an ad-hoc communication system or mesh network may be referred to as “peers.” For purposes of this disclosure, the terms “peer” and “STA” may be used interchangeably.

With the increased use of WLANs, demand for broadcasting/multicasting has also steadily increased. Users want to be able to watch videos, receive newscasts, and other local broadcast information. When multicast frames are transmitted with no ACK policy, their frame loss rates can be quite large. Frame losses can occur not only due to the signal-to-noise ratio (SNR) distribution depending on the location of the stations (STA/peer) within the network coverage area (e.g., the distance of the STA from the AP), but also due to overlapping transmissions, hidden terminal problems, etc. In some situations, when multicast frames are transmitted with an ACK policy that permits receiving ACKs from a plurality of receiving devices, the greater reliability is obtained at the cost of lower network capacity.

### SUMMARY

Aspects of the present disclosure address the conflicting requirements of reliability and maximum network capacity for data transmission by providing a method to select a plurality of leader STA/peers that may be selected to respond with an ACK message to a plurality of multicast frames broadcasted by the transmitting device (e.g., AP or another peer). In some examples, for each multicast frame broadcasted, a different leader STA may be configured to respond with an ACK message. In accordance with aspects of the present disclosure, the leader STAs may be selected based on the measured signal quality (e.g., SNR) and signal strength (received signal strength indicator (RSSI)). In some examples, the term “signal metrics” may refer to SNR, RSSI, or combination of the two. Specifically, the transmitting device may select STA/peers that experience the poorest signal reception by comparison to other STA/peers on the network as the leader STA/peers so that these selected STA/peers can then respond with an ACK message on a rotational basis to the reception of broadcasted multicast frames. The rationale for such selection is that if STAs that are farthest away from the transmitting device or are experiencing the worst signal quality are able to receive the multicast frame (e.g., confirmed by way of ACK message), then it can be presumed that receiving devices (e.g., STAs) with better signal metrics (e.g., higher SNR or RSSI) also likely received the multicast frame. As such, by limiting the number of receiving devices to a subset of STAs that respond with an ACK message in a predetermined periodic interval (e.g., by rotation schedule identified by the transmitting device), aspects of the present disclosure allow the transmitting device to ensure reliable multicast service without overloading the network bandwidth (e.g., by requiring more than one or all the receiving devices to respond with an ACK message).

In a first example, a method for wireless communications by a transmitting device is disclosed. The method may include selecting a plurality of leader STA/peers from a set of STA/peers associated with the transmitter device to respond with an ACK message to a plurality of multicast frames broadcasted by the transmitting device. The method may further include generating scheduling information that identifies which of the plurality of leader STAs is to respond with the ACK message to each of the plurality of multicast frames, and transmitting, from the transmitting device to the plurality of leader STAs, the scheduling information.

In a second example, a transmitting device for wireless communication is disclosed. The transmitting device may include a memory configured to store instructions, and a processor communicatively coupled with the memory. The processor may execute the instructions to select a plurality of leader STA/peers from a set of STA/peers associated with the transmitter device to respond with an ACK message to a plurality of multicast frames broadcasted by the transmitting device. The processor may further be configured to generate scheduling information that identifies which of the plurality of leader STAs is to respond with the ACK message to each of the plurality of multicast frames, and transmit, from the transmitting device to the plurality of leader STA/peers, the scheduling information.

In a third examples, an STA for wireless communications is described. The STA may include a memory configured to store instructions, and a processor communicatively coupled with the memory. The processor may be configured to execute the instructions to receive, at the STA/peer and from a transmitting device, scheduling information having a rotation schedule that identifies which of a plurality of leader STAs is to respond with an ACK message to each of a plurality of multicast frames broadcasted by the transmitting device. The processor may further include instructions to determine, based on the schedule information, that the STA/peer is selected by the transmitting device as one of the plurality of leader STAs. In some examples, the processor may further include instructions to receive a multicast frame of the plurality of multicast frames from the transmitting device, and determine, in response to being one of the plurality of leader STAs and based on the rotation schedule, whether to respond to the multicast frame with the ACK message.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a conceptual diagram illustrating an example of a wireless local area network (WLAN) deployment;

FIGS. 2A and 2B illustrate call flow between a transmitting device (e.g., AP) and a plurality of STAs to resolve complexities arising from failure to receive an acknowledgment of receipt of the scheduling information frame transmitted by the AP from each of the plurality of leader STAs in accordance with aspects of the present disclosure;

FIG. 3 is a call flow that illustrates the process of determining whether, for a particular multicast frame, a leader STA is to expected to respond with an ACK message based on the rotation schedule identified in the scheduling information;

FIG. 4A is a frame format of the ACK scheduling information frame transmitted by the transmitting device to one or more associated STAs in accordance with aspects of the present disclosure;

FIG. 4B is a frame format of a response to the ACK scheduling information frame transmitted by the one or more associated STAs in accordance with aspects of the present disclosure;

FIG. 5 is a timing diagram illustrating transmissions by the transmitting device (e.g., AP or STA) and one or more receiver devices (e.g., other STAs on network) associated with the AP in accordance with aspects of the present disclosure;

FIG. 6 is a schematic diagram of an aspect of an implementation of various components of the AP in accordance with various aspects of the present disclosure;

FIG. 7 is a schematic diagram of an aspect of an implementation of various components of the STA in accordance with various aspects of the present disclosure;

FIG. 8 illustrates a method implemented by a transmitting device in accordance with aspects of the present disclosure; and

FIG. 9 illustrates a method implemented by a STA in accordance with aspects of the present disclosure.

### DETAILED DESCRIPTION

Multicast frames are frames transmitted or broadcasted by a transmitting device (e.g., an AP or peer) to a plurality of receiver devices (e.g., STAs or peers) with the receiver address set to one of a set of broadcast or multicast addresses. A multicast address represents a group of recipients of a particular frame. The transmitting device maintains one multicast queue and associates a single sequence number space with all multicast and broadcast user data frames. Aspects of the present disclosure provide techniques for reliable multicast frame broadcasting by selecting a plurality of leader STAs to respond to a plurality of multicast frame with ACK messages. In some examples, a leader STA from a plurality of leader STAs expected to respond may be rotated based on rotation schedule set forth by the transmitting device (e.g., AP or STA). The term “leader STA” may refer to a STA that has been identified to respond to a particular multicast frame in accordance with a rotation schedule set forth by the transmitting device. The rotation schedule may be decided by the transmitting device and may be modified periodically or on an ad-hoc basis (e.g., when the transmitting device detects a change of signal metrics from the plurality of STAs).

Although many examples herein are illustrated with the AP acting as a transmitting device (e.g., AP broadcasting the multicast frames), it should be appreciated that in an IBSS configuration, a STA may also be the transmitting device configured to broadcast the plurality of multicast frames to a plurality of STAs on the network without the involvement of the AP. Features of the present disclosure provide an advantage over conventional systems because by using a plurality of leader STAs on a rotational basis as a source of ACK messages, the transmitting device may ensure that the broadcasted multicast frames are being reliably delivered to the receiving devices across the network/coverage area because multiple STAs in different areas of the network may experience poor signal quality due to varying reasons. Thus, by rotating which STA responds with the ACK message, the transmitting device can confirm that the multicast frames are being delivered to each intended recipient regardless of their respective signal condition. Such a system is especially beneficial when more than one STA may experience poor signal metrics (e.g., multiple STAs that may be at the edge of the coverage area).

Further, because the transmitting device selects the plurality of leader STAs based on advertised capabilities of the STA, features of the present disclosure provide for backward compatibility with STAs that may not support capabilities described herein. In such cases, the legacy STAs may be omitted from being selected as leader STAs, but still benefit from the improved reliable broadcasting.

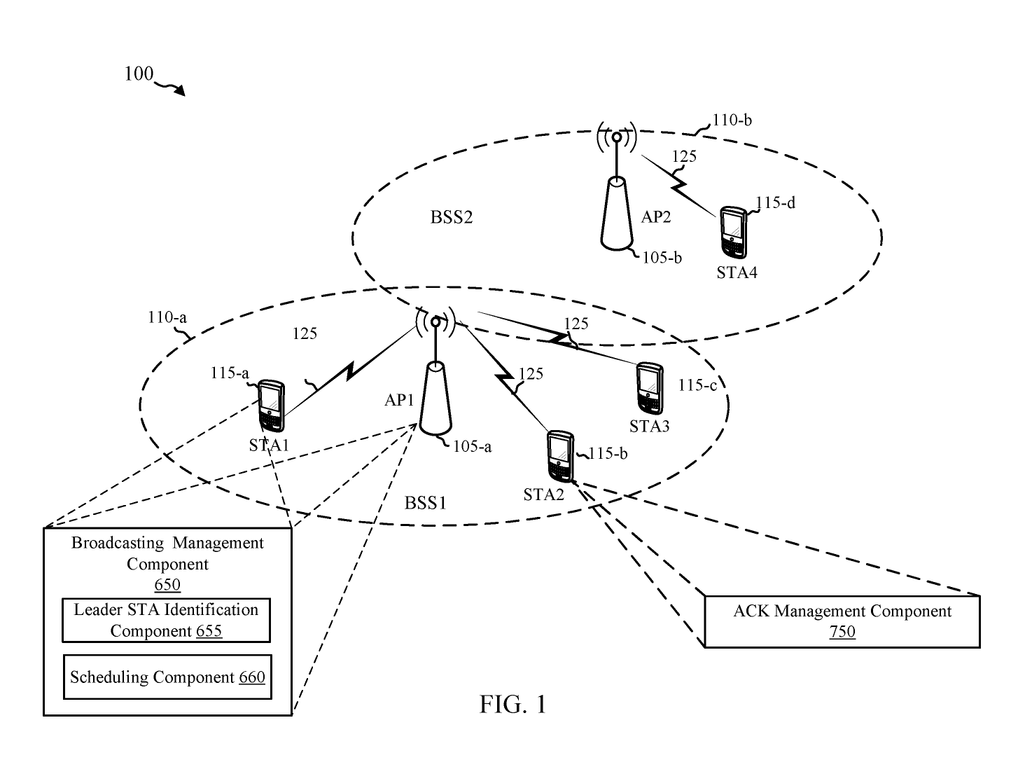

Various aspects are now described in more detail with reference to the FIGS. 1-9. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

FIG. 1 is a conceptual diagram 100 illustrating an example of a wireless local area network (WLAN) deployment in connection with various techniques described herein. The WLAN may include one or more access points (APs) and one or more stations (STAs) associated with a respective AP. In this example, there are two APs deployed: AP1 105-a in basic service set 1 (BSS1) and AP2 105-b in BSS2, which may be referred to as an OBSS. AP1 105-a is shown as having at least three associated STAs (STA1 115-a, STA2 115-b, STA3 115-c) and coverage area 110-a, while AP2 105-b is shown having one associated STA4 115-c and coverage area 110-b. The STAs and AP associated with a particular BSS may be referred to as members of that BSS. In the example of FIG. 1, the coverage area ofAPI 105-a may overlap part of the coverage area of AP2 105-b such that a STA may be within the overlapping portion of the coverage areas. The number of BSSs, APs, and STAs, and the coverage areas of the APs described in connection with the WLAN deployment of FIG. 1 are provided by way of illustration and not of limitation.

In some examples, the APs (e.g., AP1 105-a and AP2 105-b) shown in FIG. 1 are generally fixed terminals that provide backhaul services to STAs 115 within its coverage area or region. In some applications, however, the AP may be a mobile or non-fixed terminal. The STAs (e.g., STA1 115-a, STA2 115-b, STA3 115-c, STA4 115-d) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, or any other suitable terminology. The various concepts described throughout this disclosure are intended to apply to all suitable wireless apparatus regardless of their specific nomenclature.

Each of STA1 115-a, STA2 115-b, STA3 115-c, STA4 115-d may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each ofAPI 105-a and AP2 105-b can include software applications and/or circuitry to enable associated STAs to connect to a network via communications link 125. The APs can send frames or packets to their respective STAs and receive frames or packets from their respective STAs to communicate data and/or control information (e.g., signaling).

Each of AP1 105-a and AP2 105-b can establish a communications link 125 with an STA that is within the coverage area of the AP. Communications link 125 can comprise communications channels that can enable both uplink and downlink communications. When connecting to an AP, an STA can first authenticate itself with the AP and then associate itself with the AP. Once associated, a communications link 125 may be established between the AP 105 and the STA 115 such that the AP 105 and the associated STA 115 may exchange frames or messages through a direct communications channel. It should be noted that the wireless communication system, in some examples, may not have a central AP (e.g., AP 105), but rather may function as a peer-to-peer network between the STAs. Accordingly, the functions of the AP 105 described herein may alternatively be performed by one or more of the STa 115. Such systems may be referred to as an “ad-hoc” communication systems in which terminals asynchronously communication directly with each other without use of any specific AP referred to as an IBSS or mesh. Features of the present disclosure may be equally adaptable in such “ad-hoc” communication system where a broadcasting STA 115 function as the transmitting device of the plurality of multicast frames in lieu of the AP 105.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for performing operations based on modifications and enhancements to dynamic sensitivity control may be applicable to any suitable wireless network regardless of the coverage range and the wireless access protocols utilized.

In some aspects, one or more APs (105-a and 105-b) may transmit on one or more channels (e.g., multiple narrowband channels, each channel including a frequency bandwidth) a beacon signal (or simply a “beacon”), via a communications link 125 to STA(s) 115 of the wireless communication system, which may help the STA(s) 115 to synchronize their timing with the APs 105, or which may provide other information or functionality. Such beacons may be transmitted periodically. In one aspect, the period between successive beacon transmissions may be referred to as a beacon interval. Transmission of a beacon may be divided into a number of groups or intervals. In one aspect, the beacon may include, but is not limited to, such information as timestamp information to set a common clock, a peer-to-peer network identifier, a device identifier, capability information, a beacon interval, transmission direction information, reception direction information, a neighbor list, and/or an extended neighbor list, some of which are described in additional detail below. Thus, a beacon may include information that is both common (e.g., shared) amongst several devices and specific to a given device.

In accordance with aspects of the present disclosure, a transmitting device (e.g., AP1 105-a in a BSS or another STA 115 in an IBSS) may be configured to select a subset of leader STAs (e.g., STA1 115-a and STA2 115-b) from a set STAs associated with the transmitting device (e.g., STA1 115-a, STA2 115-b, and STA3 115-c) to respond with an ACK message to a plurality of multicast frames broadcasted by the transmitting device. The term “associated with” may refer to all the STAs that may communicate with the AP 105 in the BSS or are within the broadcasting range of the broadcasting STA in IBSS/mesh. The term “associated with” may also refer to those STAs that are in active communication with an AP.

For example, the AP1 105-a may include a broadcasting management component 650 for identifying the leader STAs (e.g., STA1 115-a and STA2 115-b) that will respond with an ACK message for each of multicast frames based on a rotation schedule established by the AP1 105-a. In one or more examples, the list of leader STAs may be selected by a leader STA identification component 655 based on advertised capabilities of all the STAs (e.g., STA1 115-a, STA2 115-b, STA3 115-c) associated with the AP1 105-a.

In some aspects, the AP1 105-a, upon selecting a plurality of leader STAs, may utilize scheduling component 660 to generate scheduling information that identifies which of the plurality of leader STAs will respond with the ACK message for each of the plurality of multicast frames. In some examples, a rotation schedule may be included as part of the scheduling information frame to identify how frequently each leader STA (e.g., STA1 115-a and STA2 115-b) may respond with an ACK message. In some examples, the rotation schedule may indicate an order or a sequence to be used for responding to the multicast frames by a plurality of leader STAs. In some examples, the leader STAs with good signal metrics (e.g., SNR or RSSI) may be selected less frequently than other leader STAs with poorer signal metrics by comparison. Thus, the rotation schedule may be derived by the AP 1 105-a from the received signal metrics (e.g., SNR and/or RSSI) that each STA (e.g., STA1 115-a, STA2 115-b, and STA3 115-c) associated with the AP1 105-a may periodically transmit to the AP1 105-a. In other examples, the signal metrics may be either requested on demand by the AP1 105-a from the plurality of STAs 115 or deduced from received frames. The receiving STAs (e.g., STA2 115-b) may employ an ACK management component 750 to determine whether to respond to a particular multicast frame based on the rotation schedule set forth by the transmitting device.

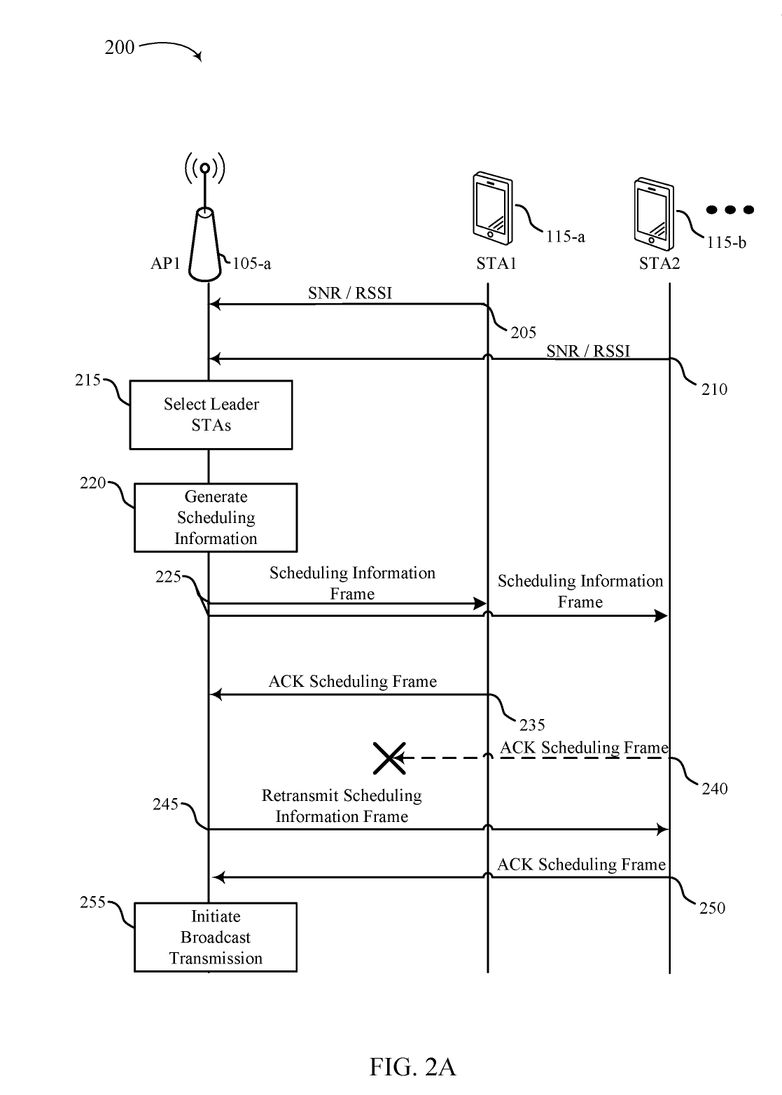

FIGS. 2A and 2B illustrate call flow between an a transmitting device (e.g., AP 105 or STA 115) and a plurality of receiver devices (e.g., STAs 115) to resolve complexities arising from failure to receive an acknowledgment of receipt of the scheduling information frame transmitted by the transmitting device from each of the plurality of leader STAs in accordance with aspects of the present disclosure. Turning first to FIG. 2A, the flowchart 200 illustrates an AP (e.g., AP1 105-a), as a transmitting device, and a plurality of STAs (e.g., STA1 115-a and STA2 115-b) as the receiver devices. As noted, the AP1 105-a may be substituted by a broadcasting STA 115 to perform the one or more steps identified in flowchart 200. Each of the AP1 105-a, STA1 115-a, and STA2 115-b may be an example of the AP 105 and STA 115 described with reference to FIG. 1.

In some examples, at 205, STA1 115-a may transmit its measured signal metrics (e.g., SNR and/or RSSI) to the AP1 105-a. At 210, the STA2 115-b may similarly transmit its corresponding signal metrics to the AP1 105-a. Although only two STAs 115 are illustrated in FIG. 2A, it should be appreciated that the AP1 105-a may receive the signal metrics from each of the STAs associated with the AP1 105-a (e.g., STA1 115-a, STA2 115-b, and STA3 115-c). Thus, in some examples, the number of STAs from which the AP1 105-a may select a plurality of leader STAs may be limited only by the total number of STAs that are associated with the AP1 105-a (e.g., all the STAs that are associated with a particular AP).

AT 215, the AP1 105-a, upon receiving the plurality of signal metrics from each STA associated with the AP1 105-a, may select a plurality of leader STAs to respond with an ACK message to a plurality of multicast frames broadcasted by the AP1 105-a. In some examples, the AP1 105-a may select a subset of leader STAs from the complete set of STAs associated with the AP based on the signal metrics (e.g., signal quality and signal strength) of each STA. For example, the AP1 105-a may select STAs that experience poor signal reception or are farthest from the AP1 105-a as the leader STAs to respond to the plurality of multicast frames on the rotational basis. A reason behind such a selection implementation is that if the STAs with poorer signal reception are able to receive a broadcasted multicast frame, the AP1 105-a may generally presume that the STAs 115 with better signal reception by comparison are more likely than not to have also received the multicast frame. As such, the AP1 105-a may not require each STA 115 to individually transmit an ACK for each multicast frame and overload the available bandwidth. In other words, this approach may reduce the overhead that would otherwise be produced if every STA had to acknowledge the broadcasted multicast frames by relying on a smaller number of STAs, and particularly, on those STAs that are more likely to suffer from poor signal reception.

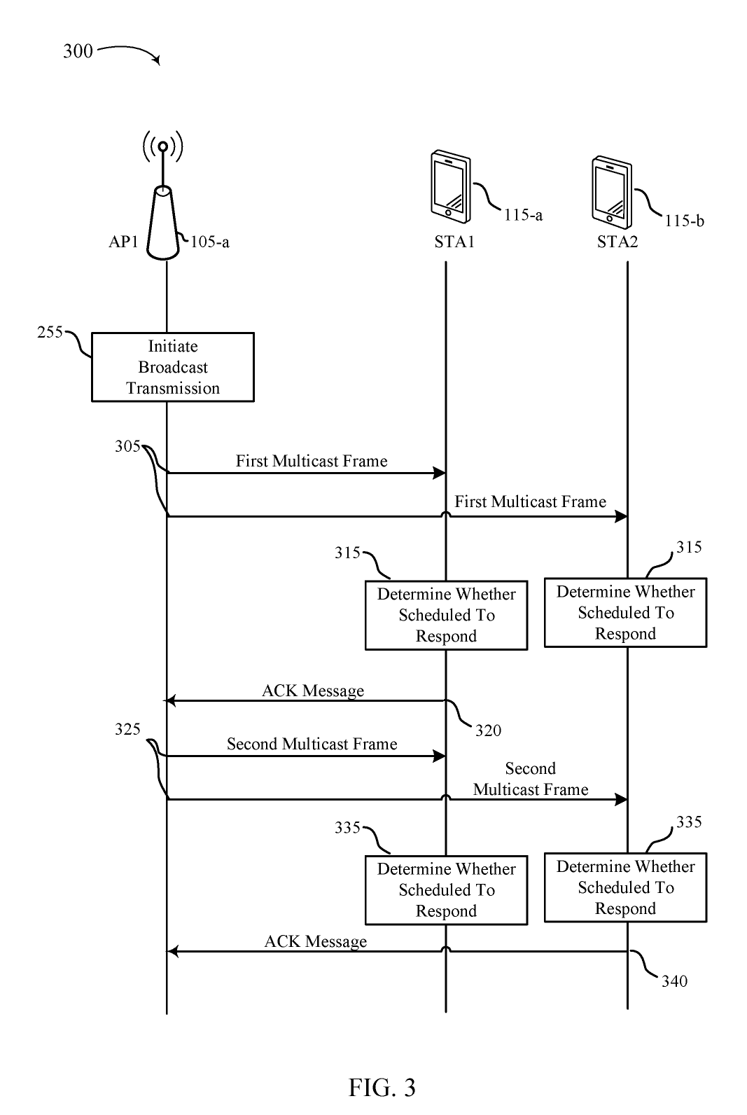

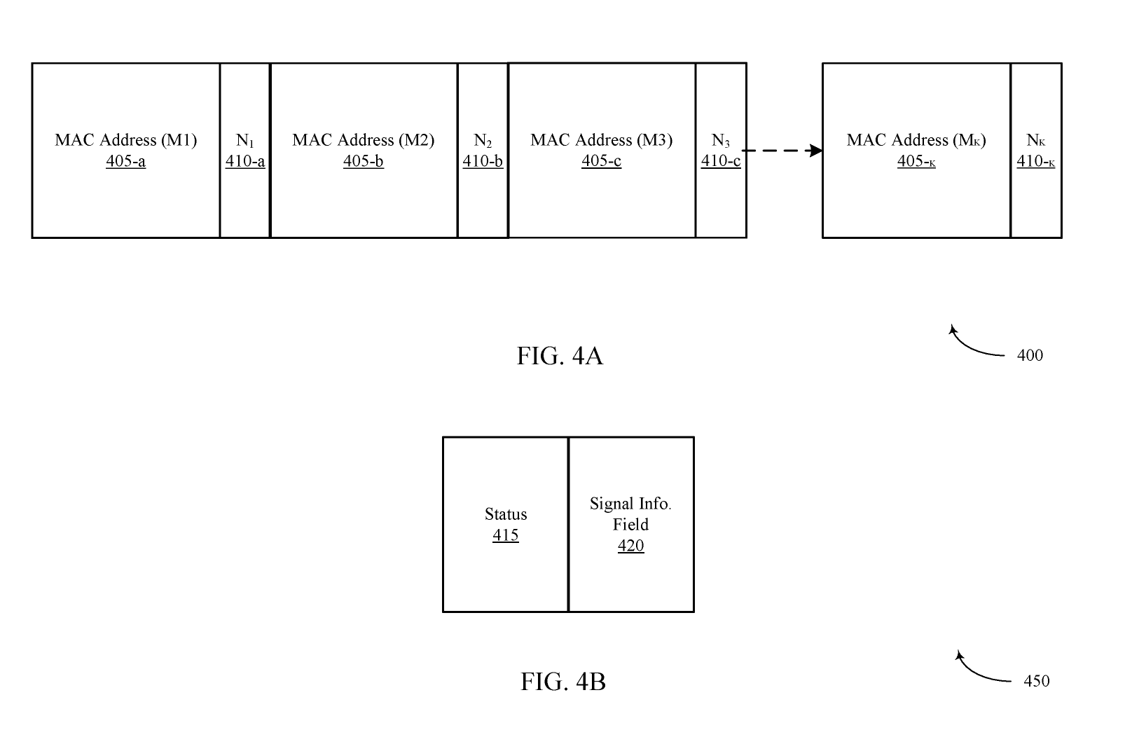

At 220,the AP1 105-a may generate scheduling information that identifies which of the plurality of leader STAs will respond with the ACK message for each of the plurality of multicast frames. In some examples, the scheduling information may include a rotation schedule that specifies how frequently each of the plurality of leader STAs may respond to each of the plurality of multicast frames. For purposes of this disclosure, the term “scheduling information” may refer to the ACK scheduling information frame that includes the MAC address, and the corresponding rotation schedule information associated with each leader STA as discussed in detail in FIG. 4A (infra). As an extension to the process of selecting the plurality of leader STAs, the AP1 105-a may set the rotation schedule based on the signal metrics received from the plurality of STAs. In some examples, the STAs with good SNR and RSSI may be chosen to transmit an ACK message less frequently than the STAs that are farther away from the AP1 105-a (in terms of distance) or experience poorer signal quality and/or strength in comparison. In some examples, the AP1 105-a may also utilize the received signal metrics from the plurality of STAs to select a packet transmission rate which would ensure that all the STAs associated with the AP1 105-a may receive the broadcasted multicast frames.

At 225, the AP1 105-a may broadcast the ACK scheduling information frame (see e.g., ACK scheduling information frame 400 in FIG. 4A) to the plurality of leader STAs (e.g., STA1 115-a and STA2 115-b) selected by the AP1 105-a to respond with an ACK message to the multicast frames. In some examples, the scheduling information frame may include MAC address of each leader STA and corresponding rotation schedule represented by an integer value that dictates the frequency of each leader STA responding to the multicast frames. In some examples, the AP1 105-a may wait on receiving an acknowledgment of receipt of the scheduling information frame from the plurality of leader STAs identified by MAC addresses in the ACK scheduling information frame before initiating the broadcast of multicast transmission. Thus, in some examples, each leader STA (e.g., STA1 115-a and STA2 115-b) may be expected to respond to the ACK scheduling information frame transmitted by the AP1 105-a.

At 235, the AP1 105-a may receive an acknowledgement of receipt of the ACK scheduling information frame from a first leader STA (e.g., STA1 115-a). However, at 240, the acknowledgement frame from the second leader STA (e.g., STA2 115-b) may be lost in transmission. Although, flowchart 200 illustrates the second leader STA transmitting the ACK scheduling frame, and the frame being lost in transmission, those of ordinary skill would appreciate the failure to receive an ACK scheduling frame may also be due to the second leader STA (e.g., STA2 115-b) not receiving the scheduling information frame broadcasted at 225.

In either instance, due to failure of the AP1 105-a to receive an acknowledgement of receipt of the ACK scheduling information frame from at least one leader STA (e.g., STA2 115-b), the AP1 105-a may, at 245, retransmit the ACK scheduling information frame to the second leader STA (e.g., STA2 115-b). Stated differently, upon detecting failure to receive, at the transmitting device, a confirmation that the transmitted ACK scheduling information frame has been received by each of the leader STAs in a form of ACK, the transmitting device may retransmit the ACK scheduling information to the leader STA from which the transmitting device failed to receive the confirmation.

In some examples, in contrast to the broadcast of the original ACK scheduling information frame at 225, the retransmission of the ACK scheduling information frame at 245 may be retransmitted as a unicast frame directly to the second leader STA (e.g., STA2 115-b)(or other leader STAs). At 250, an acknowledgment of receipt of the ACK scheduling information frame is received from the second leader STA (e.g., STA2 115-b), the AP1 105-a may initiate its broadcast transmission at 255.

However, if, as illustrated in FIG. 2B, the AP1 105-a fails to receive an acknowledgment of receipt of the retransmitted scheduling information frame at 260, the AP1 105-a may assume that the second leader STA (e.g., STA2 115-b) has left the network or the coverage area of the AP1 105-a. As such, the AP1 105-a, at 265, may update the AP associated STA list to reflect the change in STA2 115-b . At 270, the AP1 105 may regenerate a new scheduling information with the updated plurality of leader STAs that omits the second leader STA (e.g., STA2 115-b) that previously failed to respond to multiple transmissions of the scheduling information frames from its updated list of associated STA list.

At 280, the AP1 105-a may broadcast the updated scheduling information frame to the subsequent selection of plurality of leader STAs selected to respond to the multicast frames. Although flowchart 275 illustrates the AP1 105-a only broadcasting the updated scheduling information frame to a single leader STA (e.g., STA1 115-a), it should be appreciated that the updated scheduling information frame may be broadcasted to other selected leader STAs not shown in FIG. 2B that are nonetheless associated with the AP 105. At 285, the one or more updated leader STAs (e.g., STA1 115-a) may respond with acknowledgement of receipt of the updated scheduling information frame and trigger the AP1 105-a, at 255, to initiate the broadcast transmission. As noted, if the AP1 105-a fails to receive an acknowledgement of receipt, the transmitting device may pause all multicast transmissions and wait for responses from all the STAs identified in the scheduling information frame (e.g., by MAC addresses) that are expected to respond.

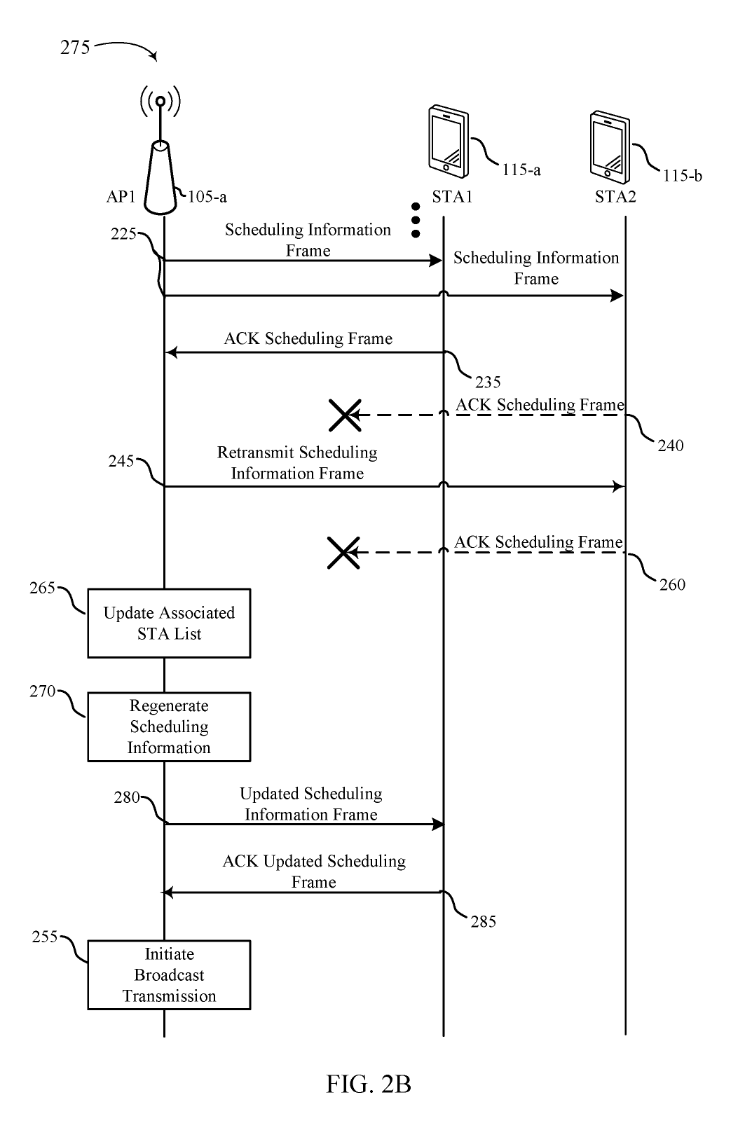

FIG. 3 is a flowchart 300 that illustrates the process of determining whether a leader STA is expected to respond with an ACK message to the multicast frames based on the rotation schedule identified in the scheduling information. In some examples, the flowchart 300 may be a continuation of flowcharts 200 and/or 275 that included transmitting an ACK scheduling information frame and receiving confirmation of receipt from each of the plurality of leader STAs selected by the AP1 105-a. Again, as noted, although an AP 105-a is illustrated as a transmitting device, it should be appreciated that a broadcasting STA 115 may be substituted as the transmitting device to perform one or more steps identified in flowchart 300.

At 255, once the plurality of leader STAs identified in the ACK scheduling information field have confirmed (and accepted) receipt of the scheduling information, the AP1 105-a may initiate broadcast transmission. At 305, the AP1 105-a may broadcast a first multicast frame to all the STAs associated with the AP 105-a. The first multicast frame may be identified by the frame sequence number (S) included as part of the first multicast frame. At 315, each leader STA from the plurality of leader STAs (e.g., STA1 115-a and STA2 115-b) may individually determine whether to respond with an ACK message to the particular multicast frame identified by the frame sequence number. In some examples, the determination may be based on a rotation schedule included in the scheduling information by the AP1 105-a. The rotation schedule may dictate the frequency of each leader STA 115-a responding to each of the multicast frames based on a process described in detail with reference to FIG. 4A (infra). In some examples, only one of the plurality of leader STAs may respond to a particular multicast frame with an ACK message.

In some examples, the leader STA selected to respond with an ACK message may dynamically change for each multicast frame based on the sequence number of the frame and the rotation schedule identified by the transmitter (e.g., AP1 105-a). For example, a first leader STA 115-a , at 320, from the plurality of leader STAs (e.g., STA1 115-a and STA2 115-b) may respond to a first multicast frame of the plurality of multicast frames. However, in response to a second multicast frame broadcasted at 325, a second leader STA 115-b, at 340, from the plurality of leader STAs may respond to a second multicast frame of the plurality of multicast frames with an ACK message after determining that the second leader STA 115-b is scheduled to respond based on the rotation schedule.

FIG. 4A is a frame format of the ACK scheduling information frame 400 transmitted by the transmitting device (e.g., AP or STA) to one or more associated STAs in accordance with various aspects of the present disclosure. In some examples, the transmitting device may include the MAC addresses 405 of each STA which is expected to respond (e.g., leader STAs) to the one or more multicast frames broadcasted by the transmitting device along with a rotation schedule 410 to guide the frequency of each STA's response. For example, first MAC address 405-a may correspond to a first leader STA (e.g., STA1 115-a) and second MAC address 405-b may correspond to a second leader STA (e.g., STA 2 115-b). It should be appreciated that any number (K) of STAs may be assigned as leader STAs from the set of STAs associated with the transmitting device. Particularly, the rotation schedule 410 may be represented by an integer value (e.g., N₁, N₂, . . . N_{K}) associated with each MAC address 405, and dictate how often (e.g., over the course of multiple multicast frames) should each leader STA respond with an ACK message to incoming multicast frames. In some examples, the integer values N₁, N₂, N_{K}, etc. associated with the rotation schedule 410 may be unique and arranged in either an ascending or descending order.

Accordingly, for each broadcasted multicast frame, each leader STA may independently determine whether the leader STA should respond to a particular multicast frame based on the following Equation:

Rₙ=modulo(S, Nₙ) Equation 1

In Equation 1, “S” may be the sequence number value (e.g., frame sequence numbers 99-105) associated with each multicast frame, and “Nₙ” may represent the rotation schedule 410 for each leader STA expected to respond to the multicast frames. Thus, each leader STA, may calculate their respective remainder value, Rₙ, to identify which of the plurality of leader STAs would respond to a particular multicast frame (e.g., frame sequence number 99). In some examples, the Rₙ value may be calculated by performing a modulo operation on the frame sequence number (S) and the rotation schedule (Nₙ) to find the remainder after the division of S by Nₙ. Thus, in some examples, the frame sequence number value (S) may operate as the dividend and the rotation schedule (Nₙ) as the divisor in the modulo operation.

In accordance with aspects of the present disclosure, the leader STA may transmit an ACK message in response to a particular multicast frame if the Rₙ value for the leader STA is zero (e.g., Rₙ=0), and no other leader STA similarly has a competing Rₙ=0 value. A conflict of two or more leader STAs each having similar Rₙ value for a particular sequence number multicast frame may be resolved by having the STA with the larger Nₖ value respond. In some aspects, if Nₖ values are not unique, the peer with highest MAC address may respond. For any leader STA that calculates Rₙ greater than zero (0), the leader STA may forego (or skip) responding to the multicast frame with an ACK message. An example application of this disclosure is illustrated in the following table (Table 1), where this example identifies which of the three leader STAs selected to respond to a plurality of multicast frames would actually respond to any particular broadcasted multicast frame based on calculations of Equation 1:

TABLE 1

| | Frame Seq. No. (S) | | | | | | |
|---|---|---|---|---|---|---|---|
| | 99 | 100 | 101 | 102 | 103 | 104 | 105 |
| ACKing STA: | MAC2 | MAC3 | MAC1 | MAC2 | MAC1 | MAC1 | MAC3 |

In the example illustrated in Table 1, the transmitting device may select three leader STAs from a set of STAs associated with the AP to respond with an ACK message to a plurality of multicast frames broadcasted by the AP. The first leader STA may be identified by a first MAC address 405-a (MAC1) and have a first rotation schedule 410-a assigned thereto (e.g., N₁=1). The second leader STA may be identified by a second MAC address 405-b (MAC2) and have a second rotation schedule 410-b assigned thereto (e.g., N₂=3). The third leader STA may be identified by a third MAC address 405-c (MAC3) and have a third rotation schedule 410-c assigned thereto (e.g., N₃=5).

For the first multicast frame (S=99), each of the three leader STAs may calculate their respective remainder values (Rₙ) by applying Equation 1 such that the dividend S (e.g., S=99) would be divided by rotation schedule (Nₙ) as the divisor (e.g., N₁=1, N₂=3, N₃=5). In the first instance, the remainders of both the first leader STA and the second leader STA would be zero (e.g., R₁=0 and R₂=0), while the third leader STA remainder value would be four (e.g., R₃=4). Thus, because only leader STAs with Rₙ value of zero may respond to a particular multicast frame, one of the first leader STA or the second leader STA may respond to the first multicast frame (S=99), while the third leader STA may forego transmitting an ACK to the incoming multicast frame for the first multicast frame. In the above example, because the second leader STA may have Nₖ value that is greater than the Nₖ value of the first leader STA, the second leader STA may respond.

For the second multicast frame (S=100), each of the three leader STAs may again calculate their respective remainder values (Rₙ). In the second instance, the remainders of both the first leader STA and the third leader STA would be zero (e.g., R₁=0 and R₃=0), while the second leader STA remainder value would be four (e.g., R₂=1). Thus, only one of the first leader STA or the third leader STA may respond to the second multicast frame (S=100), while the second leader STA may forego transmitting an ACK to the incoming multicast frame for the first multicast frame. In this example, because the third leader STA may have Nₖ value that is greater than the Nₖ value of the first leader STA, the third leader STA may respond with an ACK message.

Further, for the third multicast frame (S=101), each of the three leader STAs may again calculate their respective remainder values (Rₙ). In the third instance, the remainder of only the first leader STA would be zero (e.g., R₁=0), while both the second and third leader STAs may have a non-zero remainder value (e.g., R₂=2, R₃=1). Thus, in such instance, only the first leader STA may respond to the third multicast frame (S=101) with an ACK message, while the second and third leader STA may forego transmitting an ACK to the incoming multicast frame for the first multicast frame.

For the sake of brevity, the results of each frame subsequent to the third multicast frame (S=101) is illustrated in Table 1. It should be appreciated that although only seven frames are illustrated in Table 1, the AP may assign a rotation schedule based on the ACK scheduling information frame 500 for unlimited number of multicast frames that may follow. Thus, each of the leader STAs may continue to apply Equation 1 to determine which leader STA should respond to any particular multicast frame until either the AP dynamically adjusts the scheduling or one or more leader STAs leaves the coverage area of the AP. In which case, the AP would regenerate the scheduling information with the updated set of STAs associated with the AP. In further examples, the AP may dynamically adjust the scheduling rotation based on measured signal metrics from each of the STAs associated with the AP. In some examples, the signal metrics (e.g., SNR and/or RSSI) may be received either periodically or in response to transmission of the ACK scheduling information frame 400.

In one example, as illustrated in FIG. 4B, each leader STA may transmit an ACK scheduling information frame (ASF) response frame 450 in response to the transmitted ACK scheduling information frame 400 sent by the transmitting device. The ASF response frame 450 may be a unicast public action frame, and each of the STAs specified in the ACK scheduling information frame 400 by MAC address 405 may respond with the ASF response frame 450 that includes the status field 415 and the signal information field 420. The status field 415 may be used by the STA to either accept or reject the scheduling information transmitted by the AP. Thus, in some examples, the STA may elect to not act as a leader STA despite being assigned as one by the AP. The signal information field 420 may include the SNR and the RSSI to be reported to assist the AP to schedule the subsequent ACK scheduling information frame 400 (e.g., updated rotation schedule for subsequent assignments). In some examples, in the event that one or more STAs refuse to act as a leader STA based on ACK response frame 450, the transmitting device may transmit a new schedule in a new ACK scheduling information frame 400 that omits the one or more STAs that refused to be leader STAs.

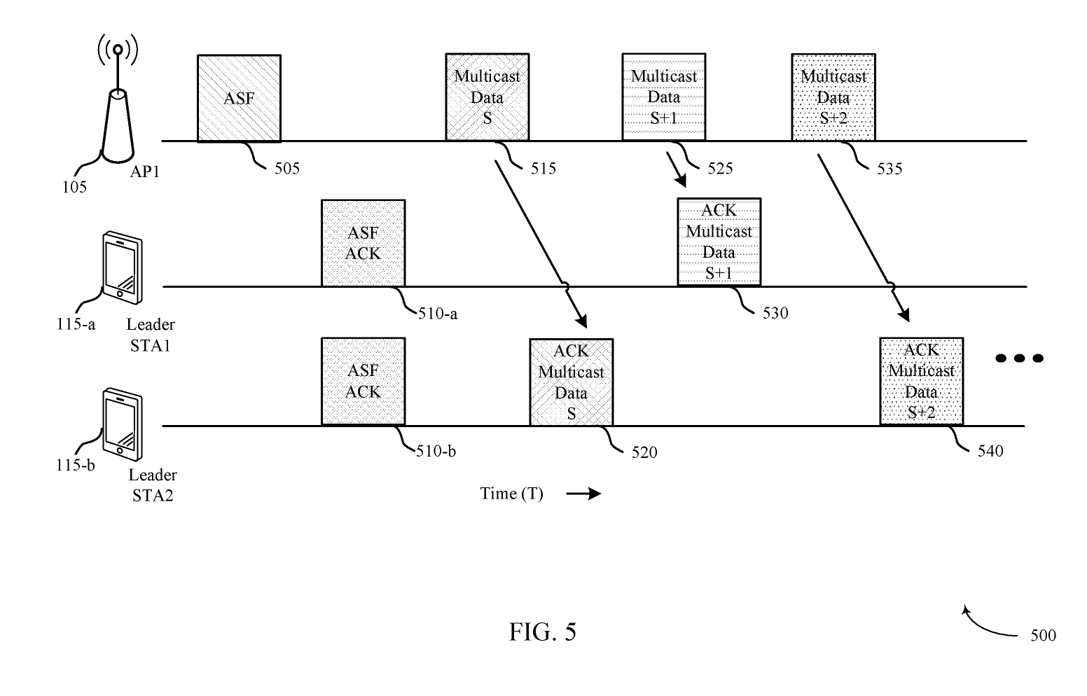

Concepts of the present disclosure are further illustrated in FIG. 5 that shows a timing diagram 500 of a frame transmission sequence by each of the AP 105 and one or more leader STAs 115 in accordance with aspects of the present disclosure.

In some example, a transmitting device (e.g., AP1 105 or STA 115) may transmit an ACK scheduling information frame 505 to one or more leader STAs selected to respond to the plurality of multicast frames. In some examples, the transmitting device may require each of the leader STAs (e.g., first leader STA 115-a and second leader STA 115-b) identified in the ACK scheduling information frame to respond with confirmation of receipt (e.g., ASF ACK 510) before the transmitting device may initiate broadcast transmission. Because only the leader STAs are identified in the ACK scheduling information frame, non-leader STAs (e.g., STA3 115-c) may not need to respond in order for the transmitting device to initiate broadcast transmission. However, as part of the network, the non-leader STAs (e.g., STA 3 115-c) may also receive the multicast frames transmitted by the transmitting device with the improved reliability of the present disclosure.

In some examples, the AP1 105 may broadcast a first multicast frame having a first frame sequence number (S) on a wireless channel that may be heard by a plurality of STAs. In the case of the AP1 105-a acting as the transmitting device, each of the STAs associated with the AP1 105-a may receive the multicast frame. Alternatively, in the case of the STA 115 acting as the transmitting device, the STAs that are in immediate proximity of the transmitting device (e.g., broadcasting range) may receive the multicast frames. However, the multicast frames may be propagated through the network by hopping across different STAs 115 without requiring access to the AP 105.

In accordance with various aspects of the present disclosure, each leader STA 115 selected to respond to the multicast frame may independently determine whether the leader STA 115 (e.g., leader STA1 115-a and leader STA2 115-b) is scheduled to respond to a particular multicast frame based on the sequence number of the frame and the rotation schedule specified in the scheduling information. In the illustrated example, the second leader STA 115-b may respond to the first multicast message 515 with an ACK message 520. For subsequent second multicast frame 525, a different leader STA (e.g., first leader STA 115-a ) may respond with an ACK message 530. Similarly, for the third multicast message 435, the second leader STA 115-b may respond with an ACK message 540. In each instance, each of the plurality of leader STAs 115 selected by the transmitting device determine whether to respond to the multicast frame by calculating their respective remainder values (Rₙ) based on Equation 1 and transmitting an ACK only if there is no other device with a higher Nₖ which has Rₖ=0.

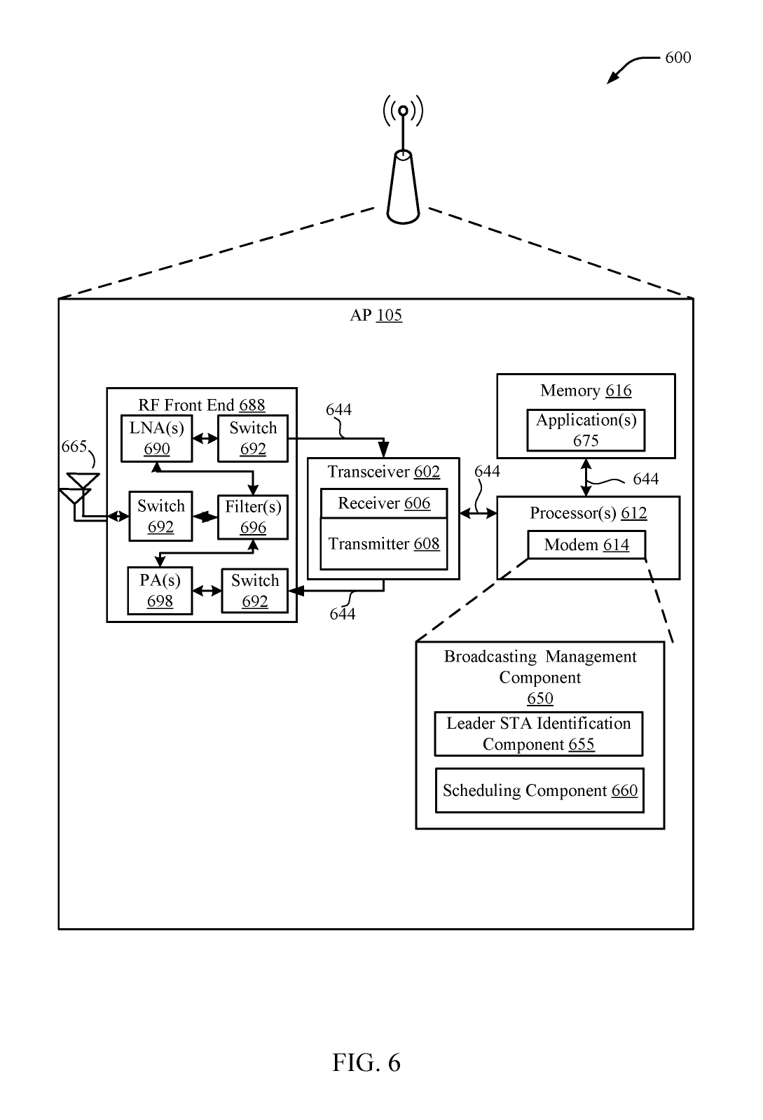

FIG. 6 describe hardware components and subcomponents of the AP 105 for implementing one or more methods (e.g., method 800 ) described herein in accordance with various aspects of the present disclosure. For example, one example of an implementation of the AP 105 may include a variety of components, some of which have already been described above, but including components such as one or more processors 612 and memory 616 and transceiver 602 in communication via one or more buses 644, which may operate in conjunction with the broadcasting management component 650 to enable one or more of the functions described herein related to including one or more methods of the present disclosure.

In some aspects, once the broadcasting management component 650 has selected a plurality of leader STAs from the STAs associated with the transmitting device to respond with an ACK message to a plurality of multicast frames broadcasted by the transmitting device, and the scheduling information has been received by each STA associated with the transmitting device, the transmitting device may initiate broadcasting the plurality of multicast frames. In some examples, the one or more processors 612, modem 614, transceiver 602, and RF front end 688 may select a first packet transmission rate based on signal metrics received from each STA in the set of STAs associated with the transmitting device. The first packet transmission rate is selected to ensure that all the STAs associated with the transmitting device receive the plurality of multicast frames. Further, the broadcasting management component 650 may determine that the transmitting device has failed to receive the ACK message for at least one multicast frame of the plurality of multicast frames from at least one leader STA from the plurality of leader STAs, and select a second packet transmission rate that is lower than the first packet transmission rate in response to the failure to receive the ACK message.

In an aspect, the one or more processors 612 can include a modem 614 that uses one or more modem processors. The various functions related to broadcasting management component 650 may be included in modem 614 and/or processors 612 and, in an aspect, can be executed by a single processor, while in other aspects, different ones of the functions may be executed by a combination of two or more different processors. For example, in an aspect, the one or more processors 612 may include any one or any combination of a modem processor, or a baseband processor, or a digital signal processor, or a transmit processor, or a receiver processor, or a transceiver processor associated with transceiver 602. In other aspects, some of the features of the one or more processors 612 and/or modem 614 associated with broadcasting management component 650 may be performed by transceiver 602.

Also, memory 616 may be configured to store data used herein and/or local versions of applications or broadcasting management component 650 and/or one or more of its subcomponents being executed by at least one processor 612. Memory 616 can include any type of computer-readable medium usable by a computer or at least one processor 612, such as random access memory (RAM), read only memory (ROM), tapes, magnetic discs, optical discs, volatile memory, non-volatile memory, and any combination thereof. In an aspect, for example, memory 616 may be a non-transitory computer-readable storage medium that stores one or more computer-executable codes defining broadcasting management component 650 and/or one or more of its subcomponents, and/or data associated therewith, when AP 105 is operating at least one processor 612 to execute broadcasting management component 650 and/or one or more of its subcomponents.

Transceiver 602 may include at least one receiver 606 and at least one transmitter 608. Receiver 606 may include hardware, firmware, and/or software code executable by a processor for receiving data, the code comprising instructions and being stored in a memory (e.g., computer-readable medium). Receiver 606 may be, for example, a radio frequency (RF) receiver. In an aspect, receiver 606 may receive signals transmitted by at least one STA 115. Additionally, receiver 606 may process such received signals, and also may obtain measurements of the signals, such as, but not limited to, Ec/Io, SNR, RSRP, RSSI, etc. Transmitter 608 may include hardware, firmware, and/or software code executable by a processor for transmitting data, the code comprising instructions and being stored in a memory (e.g., computer-readable medium). A suitable example of transmitter 608 may including, but is not limited to, an RF transmitter.

Moreover, in an aspect, transmitting device may include RF front end 688, which may operate in communication with one or more antennas 665 and transceiver 602 for receiving and transmitting radio transmissions, for example, wireless communications transmitted by at least one AP 105 or wireless transmissions transmitted by STA 115. RF front end 688 may be connected to one or more antennas 665 and can include one or more low-noise amplifiers (LNAs) 690, one or more switches 692, one or more power amplifiers (PAs) 698, and one or more filters 696 for transmitting and receiving RF signals.

In an aspect, LNA 690 can amplify a received signal at a desired output level. In an aspect, each LNA 690 may have a specified minimum and maximum gain values. In an aspect, RF front end 688 may use one or more switches 692 to select a particular LNA 690 and its specified gain value based on a desired gain value for a particular application.

Further, for example, one or more PA(s) 698 may be used by RF front end 688 to amplify a signal for an RF output at a desired output power level. In an aspect, each PA 698 may have specified minimum and maximum gain values. In an aspect, RF front end 688 may use one or more switches 692 to select a particular PA 698 and its specified gain value based on a desired gain value for a particular application.

Also, for example, one or more filters 696 can be used by RF front end 688 to filter a received signal to obtain an input RF signal. Similarly, in an aspect, for example, a respective filter 696 can be used to filter an output from a respective PA 698 to produce an output signal for transmission. In an aspect, each filter 696 can be connected to a specific LNA 690 and/or PA 698. In an aspect, RF front end 688 can use one or more switches 692 to select a transmit or receive path using a specified filter 696, LNA 690, and/or PA 698, based on a configuration as specified by transceiver 602 and/or processor 612.

As such, transceiver 602 may be configured to transmit and receive wireless signals through one or more antennas 665 via RF front end 688. In an aspect, transceiver may be tuned to operate at specified frequencies such that transmitting device can communicate with, for example, one or more STAs 115 or one or more BSS associated with one or more AP 105. In an aspect, for example, modem 614 can configure transceiver 602 to operate at a specified frequency and power level based on the configuration of the transmitting device and the communication protocol used by modem 614.

In an aspect, modem 614 can process digital data and communicate with transceiver 602 such that the digital data is sent and received using transceiver 602. In an aspect, modem 614 can be multiband and be configured to support multiple frequency bands for a specific communications protocol. In an aspect, modem 614 can be multimode and be configured to support multiple operating networks and communications protocols. In an aspect, modem 614 can control one or more components of transmitting device (e.g., RF front end 688, transceiver 602) to enable transmission and/or reception of signals from the network based on a specified modem configuration. In an aspect, the modem configuration can be based on the mode of the modem and the frequency band in use.

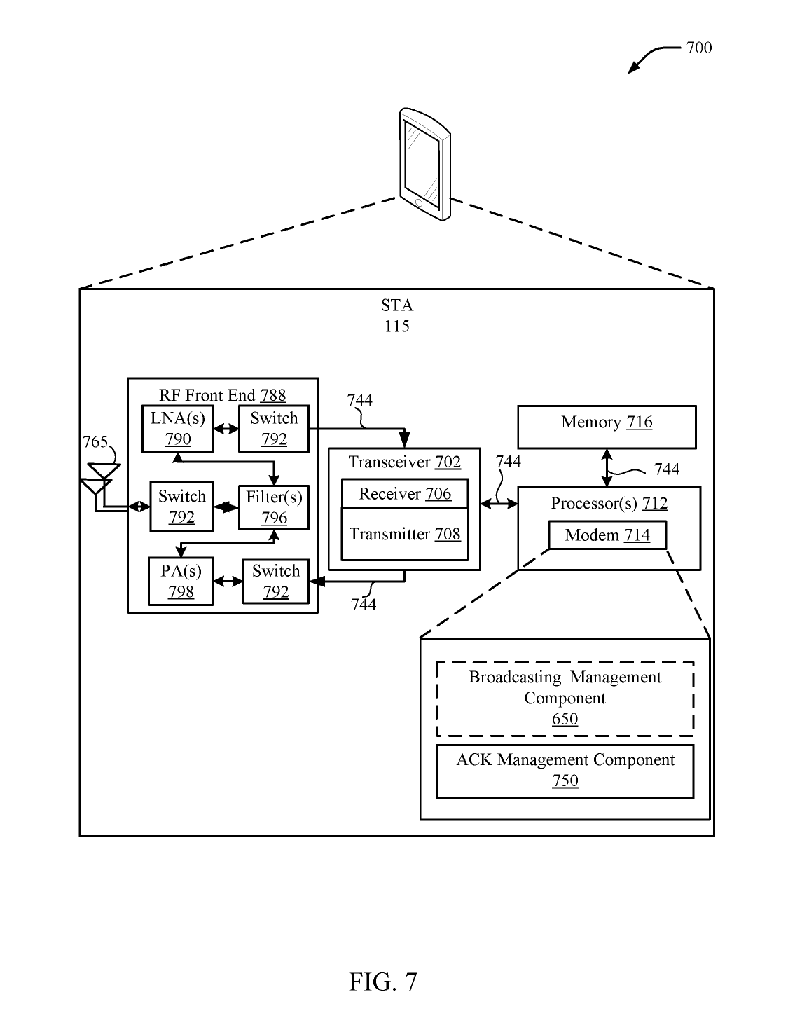

FIG. 7 describe hardware components and subcomponents of the STA 115 for implementing one or more methods (e.g., method 900 ) described herein in accordance with various aspects of the present disclosure. For example, one example of an implementation of the STA 115 may include a variety of components, some of which have already been described above, but including components such as one or more processors 712 and memory 716 and transceiver 702 in communication via one or more buses 744, which may operate in conjunction with the broadcasting management component 650 (when the STA 115 is acting as the transmitting device) and ACK management component 750 (when the STA 115 is acting as one of a plurality of leader STAs) to enable one or more of the functions described herein related to including one or more methods of the present disclosure. Further, the one or more processors 712, modem 714, memory 716, transceiver 702, RF front end 788 and one or more antennas 765, may be configured to support voice and/or data calls (simultaneously or non-simultaneously) in one or more radio access technologies. In some examples, the ACK management component 750 may be configured to process the received scheduling information and determine, based on the schedule information, that the STA is selected by the transmitting device as one of the plurality of leader STAs. If the STA is identified as a leader STA, for each multicast frame received, the STA may determine whether to respond to the multicast frame (e.g., a particular multicast frame from the plurality of multicast frames) based on the rotation schedule set forth in the ACK scheduling information frame sent by the transmitting device.

In an aspect, the one or more processors 712 can include a modem 714 that uses one or more modem processors. The various functions related to ACK management component 750 may be included in modem 714 and/or processors 712 and, in an aspect, can be executed by a single processor, while in other aspects, different ones of the functions may be executed by a combination of two or more different processors. For example, in an aspect, the one or more processors 712 may include any one or any combination of a modem processor, or a baseband processor, or a digital signal processor, or a transmit processor, or a receiver processor, or a transceiver processor associated with transceiver 702. In other aspects, some of the features of the one or more processors 712 and/or modem 714 associated with ACK management component 750 may be performed by transceiver 702.

Also, memory 716 may be configured to store data used herein and/or local versions of applications or ACK management component 750 and/or one or more of its subcomponents being executed by at least one processor 712. Memory 716 can include any type of computer-readable medium usable by a computer or at least one processor 712, such as random access memory (RAM), read only memory (ROM), tapes, magnetic discs, optical discs, volatile memory, non-volatile memory, and any combination thereof. In an aspect, for example, memory 716 may be a non-transitory computer-readable storage medium that stores one or more computer-executable codes defining ACK management component 750 and/or one or more of its subcomponents, and/or data associated therewith, when STA 115 is operating at least one processor 712 to execute ACK management component 750 and/or one or more of its subcomponents.

Transceiver 702 may include at least one receiver 706 and at least one transmitter 708. Receiver 706 may include hardware, firmware, and/or software code executable by a processor for receiving data, the code comprising instructions and being stored in a memory (e.g., computer-readable medium). Receiver 706 may be, for example, a radio frequency (RF) receiver. In an aspect, receiver 706 may receive signals transmitted by at least one AP 105 or another STA 115. Additionally, receiver 706 may process such received signals, and also may obtain measurements of the signals, such as, but not limited to, Ec/Io, SNR, RSRP, RSSI, etc. Transmitter 708 may include hardware, firmware, and/or software code executable by a processor for transmitting data, the code comprising instructions and being stored in a memory (e.g., computer-readable medium). A suitable example of transmitter 608 may including, but is not limited to, an RF transmitter.

Moreover, in an aspect, transmitting device may include RF front end 788, which may operate in communication with one or more antennas 765 and transceiver 702 for receiving and transmitting radio transmissions, for example, wireless communications transmitted by at least one AP 105 or wireless transmissions transmitted by STA 115. RF front end 788 may be connected to one or more antennas 765 and can include one or more low-noise amplifiers (LNAs) 790, one or more switches 792, one or more power amplifiers (PAs) 798, and one or more filters 796 for transmitting and receiving RF signals.

In an aspect, LNA 790 can amplify a received signal at a desired output level. In an aspect, each LNA 790 may have a specified minimum and maximum gain values. In an aspect, RF front end 788 may use one or more switches 792 to select a particular LNA 790 and its specified gain value based on a desired gain value for a particular application.

Further, for example, one or more PA(s) 798 may be used by RF front end 688 to amplify a signal for an RF output at a desired output power level. In an aspect, each PA 798 may have specified minimum and maximum gain values. In an aspect, RF front end 788 may use one or more switches 792 to select a particular PA 798 and its specified gain value based on a desired gain value for a particular application.

Also, for example, one or more filters 796 can be used by RF front end 788 to filter a received signal to obtain an input RF signal. Similarly, in an aspect, for example, a respective filter 796 can be used to filter an output from a respective PA 798 to produce an output signal for transmission. In an aspect, each filter 796 can be connected to a specific LNA 790 and/or PA 798. In an aspect, RF front end 788 can use one or more switches 692 to select a transmit or receive path using a specified filter 796, LNA 790, and/or PA 798, based on a configuration as specified by transceiver 702 and/or processor 712.

As such, transceiver 702 may be configured to transmit and receive wireless signals through one or more antennas 765 via RF front end 788. In an aspect, transceiver may be tuned to operate at specified frequencies such that transmitting device can communicate with, for example, one or more STAs 115 or one or more BSS associated with one or more AP 105. In an aspect, for example, modem 714 can configure transceiver 702 to operate at a specified frequency and power level based on the configuration of the transmitting device and the communication protocol used by modem 714.

In an aspect, modem 714 can be a multiband modem, which can process digital data and communicate with transceiver 702 such that the digital data is sent and received using transceiver 702. In an aspect, modem 714 can be multiband and be configured to support multiple frequency bands for a specific communications protocol. In an aspect, modem 714 can be configured to support multiple operating networks and communications protocols. In an aspect, modem 714 can control one or more components of transmitting device (e.g., RF front end 788, transceiver 72) to enable transmission and/or reception of signals from the network based on a specified modem configuration. In an aspect, the modem configuration can be based on the frequency band in use. In another aspect, the modem can be configured based on STA/peer configuration information associated with transmitting device as provided by the network during BSS selection and/or BSS reselection.

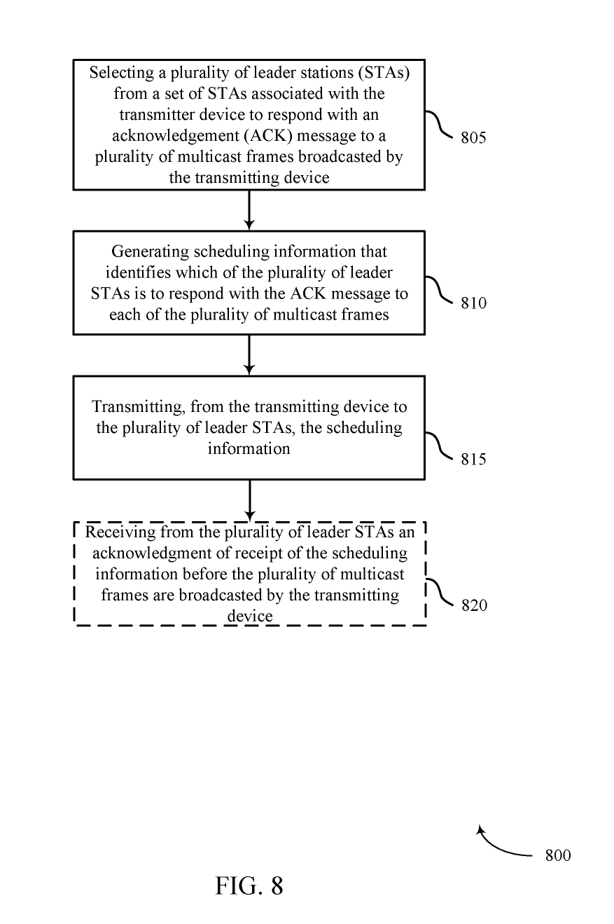

FIG. 8 is a flowchart of an example method 800 of aspects of the present disclosure. The method 800 may be performed by a transmitting device (e.g., AP 105 or STA 115) as described with reference to FIGS. 1-4. Although the method 800 is described below with respect to the elements of the AP 105 or STA 115, other components may be used to implement one or more of the steps described herein.

At block 805, the method may include selecting a plurality of leader STAs from a set of STAs associated with the transmitter device to respond with an ACK message to a plurality of multicast frames broadcasted by the transmitting device. In some examples, the plurality of leader STAs may be selected based on receiving, from each STA in the set of STAs, advertised capabilities, and determining, by the transmitting device, which of the STAs associated with the transmitting device is capable of functioning as one of the plurality of leader STAs. Aspects of block 805 may be performed by leader STA identification component 650 described with reference to FIG. 6.

At block 810, the method may include generating scheduling information that identifies which of the plurality of leader STAs is to respond with the ACK message to each of the plurality of multicast frames. In some examples, generating the scheduling information that identifies which of the plurality of leader STAs is to respond with the ACK message to each of the plurality of multicast frames comprises selecting a first leader STA from the plurality of leader STAs to respond to a first multicast frame of the plurality of multicast frames, and selecting a second leader STA from the plurality of leader STAs to respond to a second multicast frame of the plurality of multicast frames. The first leader STA and the second leader STA may be different. Similarly, it should be understood that the first multicast frame having a first sequence number may be different from the second multicast frame having a second sequence number.

In some examples, the scheduling information that identifies which of the plurality of leader STAs is to respond with the ACK message to each of the plurality of multicast frames includes a rotation schedule that indicates how frequently each of the plurality of leader STAs is to respond to each of the plurality of multicast frames. The scheduling information may be transmitted from the transmitting device to the leader STAs via ACK scheduling information frame (see FIG. 5A) that identifies the MAC address associated with each STA and a corresponding integer value (e.g., rotation schedule) that dictates how often the STA identified by the MAC address is to acknowledge incoming multicast frames. The rotation schedule of the plurality of leader STAs may be determined based on received signal metrics (e.g., SNR, RSSI, or both) of each STA in the set of STAs associated with the transmitting device.

In one aspects, the rotation schedule of the plurality of leader STAs may be determined based on signal metrics received from each STA in the set of STAs associated with the transmitting device. In order to determine the rotation schedule, the transmitting device may compare the received signal metrics from each of the STAs against each other to identify the STAs that are experiencing the poorest signal quality. For example, the transmitting device may compare a first received signal metric from a first leader STA in the set of STAs associated with the transmitting device against a second received signal metric from a second leader STA in the set of STAs associated with the transmitting device. Accordingly, the transmitting device may select the first leader STA from the plurality of leader STAs to respond with the ACK message more frequently to the plurality of multicast frames than the second leader STA from the plurality of leader STAs. In some examples, the first received signal metric may be less (e.g., poorer signal quality based on SNR, RSSI, or both) than the second received signal metric. Stated differently, STAs with good signal may be selected less often to respond with the ACK than STAs with worse signal by comparison. Aspects of block 810 may be performed by scheduling component 660 described with reference to FIG. 6.

At block 815, the method may include transmitting, from the transmitting device to the plurality of leader STAs, the scheduling information. Aspects of block 815 may be performed by the AP transceiver 602 described with reference to FIG. 6.

At block 820, the method may include receiving from the plurality of leader STAs an acknowledgment of receipt of the scheduling information before the plurality of multicast frames are broadcasted by the transmitting device. In some examples, the transmitting device may determine that the acknowledgment of receipt of the scheduling information is not received from at least one leader STA from the plurality of leader STAs. In such instance, after multiple retransmissions (and failures to receive an acknowledgment of the ACK scheduling information frame), the transmitting device may presume that that the leader STA, from which the acknowledgment receipt was not received, has left the network (e.g., the coverage area 110-a of the AP1 105-a). Thus, the transmitting device may update the set of STAs associated with the transmitting device to omit the at least one leader STA from which the acknowledgment receipt was not received (e.g., due to loss of the ACK transmitted by the leader STA or the leader STA never receiving the scheduling information in the first place). In some examples, the transmitting device may regenerate the scheduling information with updated scheduling information, wherein the updated scheduling information omits the at least one leader STA from selection as one of the plurality of leader STAs. Aspects of block 820 may be performed by the AP transceiver 602 in conjunction with the modem 614 described with reference to FIG. 6.

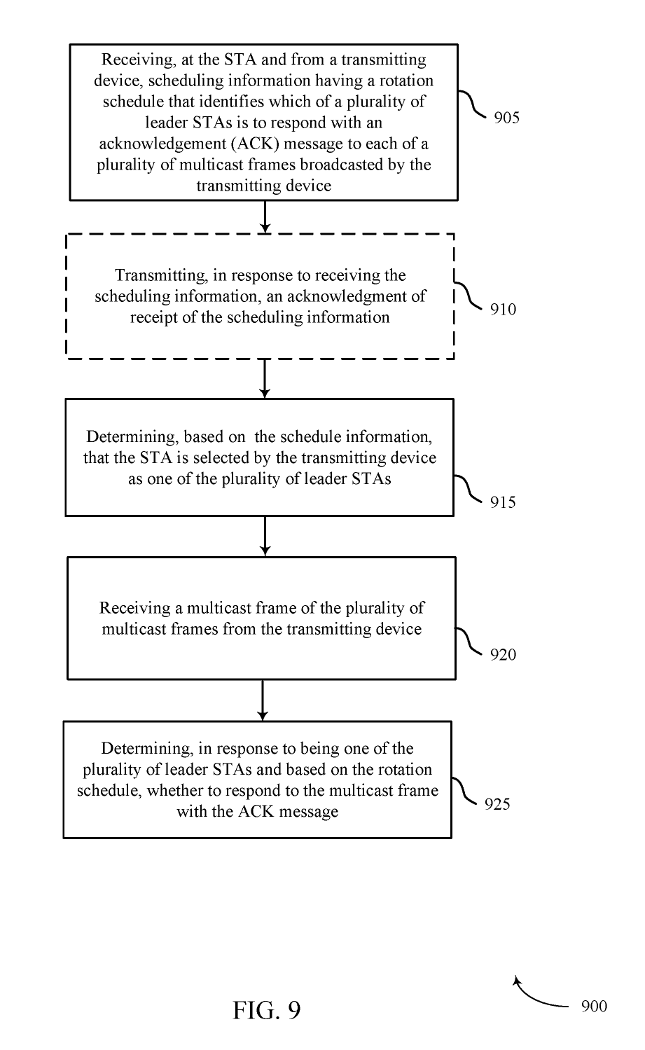

FIG. 9 is a flowchart of an example method 900 of aspects of the present disclosure. The method 900 may be performed by a STA 115 as described with reference to FIGS. 1-4. Although the method 900 is described below with respect to the elements of the STA 115, other components may be used to implement one or more of the steps described herein.

At block 905, the method may include receiving, at the STA and from a transmitting device, scheduling information having a rotation schedule that identifies which of a plurality of leader STAs is to respond with an ACK message to each of a plurality of multicast frames broadcasted by the transmitting device. In some examples, the scheduling information may include sequence numbers of the plurality of multicast frames and a rotation schedule that allows the STA to independently determine which STA should acknowledge the multicast frame. The rotation schedule may indicate how frequently each the plurality of leader STAs is to respond to each of the plurality of multicast frames broadcasted by the transmitting device. Aspects of block 905 may be performed by STA transceiver 702 described with reference to FIG. 7.

At block 910, the method may optionally include transmitting the ACK message to the transmitting device in response to determining that the STA is scheduled to respond to the multicast frame based on the rotation schedule. Aspects of block 905 may be performed by STA transceiver 702 described with reference to FIG. 7.

At block 915, the method may include determining, based on the schedule information, that the STA is selected by the transmitting device as one of the plurality of leader STAs. Aspects of block 915 may be performed by ACK management component 750 described with reference to FIG. 7.

At block 920, the method may include receiving a multicast frame of the plurality of multicast frames from the transmitting device. In some examples, the multicast frame may be associated with a sequence number. Aspects of block 920 may also be performed by STA transceiver 702 described with reference to FIG. 7.

At block 925, the method may include determining, in response to being one of the plurality of leader STAs and based on the rotation schedule, whether to respond to the multicast frame with the ACK message. Each leader STA may independently determine whether to respond to the multicast frame with an ACK message. In some examples, the leader STA may transmit the ACK message to the transmitting device in response to determining that the STA is scheduled to respond to the multicast frame based on the rotation schedule. Alternatively, the leader STA may elect to not transmit the ACK message upon determining that the STA is not scheduled to respond to the multicast frame based on the rotation schedule included in the scheduling information. Aspects of block 925 may be performed by ACK management component 750 described with reference to FIG. 7.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for.”

What is claimed is:

1. A method for wireless communications by a transmitting device, comprising:
selecting a plurality of leader stations (STAs) from a set of STAs associated with the transmitter device to respond with an acknowledgement (ACK) message to a plurality of multicast frames broadcasted by the transmitting device;
generating scheduling information that identifies which of the plurality of leader STAs is to respond with the ACK message to each of the plurality of multicast frames; and
transmitting, from the transmitting device to the plurality of leader STAs, the scheduling information.

2. The method of claim 1, wherein generating the scheduling information that identifies which of the plurality of leader STAs is to respond with the ACK message to each of the plurality of multicast frames comprises:
selecting a first leader STA from the plurality of leader STAs to respond to a first multicast frame of the plurality of multicast frames; and
selecting a second leader STA from the plurality of leader STAs to respond to a second multicast frame of the plurality of multicast frames.

3. The method of claim 1, wherein the scheduling information that identifies which of the plurality of leader STAs is to respond with the ACK message to each of the plurality of multicast frames includes:
a rotation schedule that indicates how frequently each of the plurality of leader STAs is to respond to each of the plurality of multicast frames.

4. The method of claim 3, wherein the rotation schedule of the plurality of leader STAs is determined based on signal metrics received from each STA in the set of STAs associated with the transmitting device.

5. The method of claim 1, further comprising:
comparing a first received signal metric from a first leader STA in the set of STAs associated with the transmitting device against a second received signal metric from a second leader STA in the set of STAs associated with the transmitting device; and
selecting the first leader STA from the plurality of leader STAs to respond with the ACK message more frequently to the plurality of multicast frames than the second leader STA from the plurality of leader STAs, wherein the first received signal metric are less than the second received signal metric.

6. The method of claim 1, further comprising:
receiving from the plurality of leader STAs an acknowledgment of receipt of the scheduling information before the plurality of multicast frames are broadcasted by the transmitting device.

7. The method of claim 6, further comprising:
determining that the acknowledgment of receipt of the scheduling information is not received from at least one leader STA from the plurality of leader STAs;
updating the set of STAs associated with the transmitting device to omit the at least one leader STA from which the acknowledgment receipt was not received; and
regenerating the scheduling information with updated scheduling information, wherein the updated scheduling information omits the at least one leader STA from selection as one of the plurality of leader STAs.

8. The method of claim 1, further comprising:
selecting a first packet transmission rate based on signal metrics received from each STA in the set of STAs associated with the transmitting device, wherein the first packet transmission rate is selected to ensure that all the STAs associated with the transmitting device receive the plurality of multicast frames.

9. The method of claim 8, further comprising:
determining that the transmitting device has failed to receive the ACK message for at least one multicast frame of the plurality of multicast frames from at least one leader STA from the plurality of leader STAs; and
selecting a second packet transmission rate that is lower than the first packet transmission rate in response to the failure to receive the ACK message.

10. The method of claim 1, wherein selecting the plurality of leader STAs from the set of STAs associated with the transmitting device comprises:
receiving, from each STA in the set of STAs, advertised capabilities; and
determining, by the transmitting device, which of the STAs associated with the transmitting device is capable of functioning as one of the plurality of leader STAs.

11. A station (STA) for wireless communications, comprising:
a memory configured to store instructions;
a processor communicatively coupled with the memory, the processor configured to execute the instructions to:
receive, at the STA and from a transmitting device, scheduling information having a rotation schedule that identifies which of a plurality of leader STAs is to respond with an acknowledgement (ACK) message to each of a plurality of multicast frames broadcasted by the transmitting device;
determine, based on the schedule information, that the STA is selected by the transmitting device as one of the plurality of leader STAs;
receive a multicast frame of the plurality of multicast frames from the transmitting device; and
determine, in response to being one of the plurality of leader STAs and based on the rotation schedule, whether to respond to the multicast frame with the ACK message.

12. The STA of claim 11, wherein the processor is further configured to:
transmit the ACK message to the transmitting device in response to determining that the STA is scheduled to respond to the multicast frame based on the rotation schedule.

13. The STA of claim 11, wherein the rotation schedule indicates how frequently each the plurality of leader STAs is to respond to each of the plurality of multicast frames broadcasted by the transmitting device.

14. A transmitting device for wireless communications, comprising:
a memory configured to store instructions;
a processor communicatively coupled with the memory, the processor configured to execute the instructions to:
select a plurality of leader stations (STAs) from a set of STAs associated with the transmitter device to respond with an acknowledgement (ACK) message to a plurality of multicast frames broadcasted by the transmitting device;
generate scheduling information that identifies which of the plurality of leader STAs is to respond with the ACK message to each of the plurality of multicast frames; and
transmit, from the transmitting device to the plurality of leader STAs, the scheduling information.

15. The transmitting device of claim 14, wherein the processor is further configured to:
select a first leader STA from the plurality of leader STAs to respond to a first multicast frame of the plurality of multicast frames; and
select a second leader STA from the plurality of leader STAs to respond to a second multicast frame of the plurality of multicast frames.

16. The transmitting device of claim 14, wherein the scheduling information that identifies which of the plurality of leader STAs is to respond with the ACK message to each of the plurality of multicast frames includes:
a rotation schedule that indicates how frequently each of the plurality of leader STAs is to respond to each of the plurality of multicast frames.

17. The transmitting device of claim 16, wherein the rotation schedule of the plurality of leader STAs is determined based on signal metrics received from each STA in the set of STAs associated with the transmitting device.

18. The transmitting device of claim 14, wherein the processor is further configured to:
compare a first received signal metric from a first leader STA in the set of STAs associated with the transmitting device against a second received signal metric from a second leader STA in the set of STAs associated with the transmitting device; and
select the first leader STA from the plurality of leader STAs to respond with the ACK message more frequently to the plurality of multicast frames than the second leader STA from the plurality of leader STAs, wherein the first received signal metric are less than the second received signal metric.

19. The transmitting device of claim 14, wherein the processor is further configured to:
receive from the plurality of leader STAs an acknowledgment of receipt of the scheduling information before the plurality of multicast frames are broadcasted by the transmitting device.

20. The transmitting device of claim 19, wherein the processor is further configured to:
determine that the acknowledgment of receipt of the scheduling information is not received from at least one leader STA from the plurality of leader STAs;
update the set of STAs associated with the transmitting device to omit the at least one leader STA from which the acknowledgment receipt was not received; and
regenerate the scheduling information with updated scheduling information, wherein the updated scheduling information omits the at least one leader STA from selection as one of the plurality of leader STAs.
